(19) United States
(12) Patent Application Publication
(10) Pub. No.: US 2015/0304822 A1
(43) Pub. Date: Oct. 22, 2015

(54) METHOD AND APPARATUS FOR CONTROLLING BEACON OF ELECTRONIC DEVICE

(71) Applicant: Samsung Electronics Co., Ltd., Gyeonggi-do (KR)

(72) Inventors: Youngeun Han, Gyeonggi-do (KR); Kwangsub Son, Gyeonggi-do (KR); Sungho Son, Daegu (KR); Wonsuk Choi, Seoul (KR)

(21) Appl. No.: 14/678,886

(22) Filed: Apr. 3, 2015

(30) Foreign Application Priority Data
Apr. 21, 2014 (KR) 10-2014-0047409

(51) Int. Cl. H04W 4/06; H04W 4/00; H04W 52/02; H04W 4/20

(52) U.S. Cl. CPC H04W 4/06; H04W 4/206; H04W 4/008; H04W 52/0229

(57) ABSTRACT

A method and an apparatus for controlling a beacon of an electronic device is disclosed. A method of controlling a beacon of an electronic device according to various embodiments of the present disclosure includes receiving a beacon including situation information, analyzing the received situation information and generating a changed beacon according to the situation information, and transmitting the generated beacon.

### CROSS-REFERENCE TO RELATED APPLICATION AND CLAIM OF PRIORITY

The present application is related to and claims priority from and the benefit under 35 U.S.C. §119(a) of Korean Patent Application No. 10-2014-0047409, filed on Apr. 21, 2014, which is hereby incorporated by reference for all purposes as if fully set forth herein.

### TECHNICAL FIELD

The present disclosure relates to a method and an apparatus for controlling a beacon of an electronic device.

### BACKGROUND

Recently, as a communication technique replacing a Near Field Communication (NFC), which is a short range wireless communication, a BLUETOOTH Low Energy (BLE) beacon which utilizes a BLE has been proposed. The BLE beacon is used in various fields such as situation marketing, a purchase an automatic check in in addition to a provision of simple position information. While an effective communication distance of the NFC is limited to about 4 cm through 20 cm, an effective communication distance of the BLE beacon has been expanded to about 5 cm through 50 cm. In addition, while separate chips should be installed in each electronic device in the NFC, the BLE beacon can perform a short range wireless communication using a beacon if the BLE beacon has a function of recognizing the BLE. Therefore, the BLE beacon is more economical compared to the NFC, and the BLE beacon can provide a wireless communication service in a wide indoors. The BLE beacon, which has low power consumption, allowing wireless communication service for more than one year using a battery the size of a coin, is advantageous. In addition, the number of slave devices of a previous version of BLUETOOTH is limited up to seven, but a recent version of BLE 4.0 can be synchronized with unlimited slave devices. BLE beacon techniques can transmit (i.e., broadcasting) after putting information in a packet, and can advertise various pieces of information (such as an image, a video and the like) in one electronic device.

### SUMMARY

However, as described above, the beacon periodically advertises fixed data according to a user input or a predetermined configuration.

To address the above-discussed deficiencies, it is a primary object to provide a method and an apparatus capable of providing a beacon signal of which a type, a period, information or the like of a beacon packet to be transmitted next time is changed based on received beacon signal information.

According to various embodiments of the present disclosure, a method includes receiving a beacon including situation information, analyzing the received situation information and generating a changed beacon according to the situation information, and transmitting the generated beacon.

According to various embodiments of the present disclosure, an apparatus includes a communication unit that transmits and receives a beacon, and a control unit that receives a beacon including situation information, analyzes the received situation information, generates a changed beacon according to the situation information, and transmits the generated beacon.

An electronic device according to various embodiments of the present disclosure automatically changes a beacon packet to be transmitted next time based on received beacon signal information, and thus a beaconing suitable for a situation and an environment is possible without a user input.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a configuration of an electronic device including a touch device according to various embodiments of the present disclosure;

FIG. 2 illustrates a beacon according to various embodiments of the present disclosure;

FIG. 3 illustrates components used in the process for transmitting and receiving a beacon according to various embodiments of the present disclosure;

FIG. 4 illustrates an exemplary process for transmitting a changed beacon according to situation information in a transmitting electronic device according to various embodiments of the present disclosure;

FIG. 5 illustrates an exemplary process for generating a changed beacon according to situation information according to various embodiments of the present disclosure;

FIG. 6 illustrates a signal flow between a first electronic device and a second electronic device according to various embodiments of the present disclosure;

FIG. 7 illustrates an exemplary process for generating a changed beacon according to situation information according to various embodiments of the present disclosure;

FIG. 8 illustrates an exemplary process for generating a changed beacon according to situation information according to various embodiments of the present disclosure; and

FIG. 9 illustrates an exemplary process for generating a changed beacon according to situation information according to various embodiments of the present disclosure.

### DETAILED DESCRIPTION

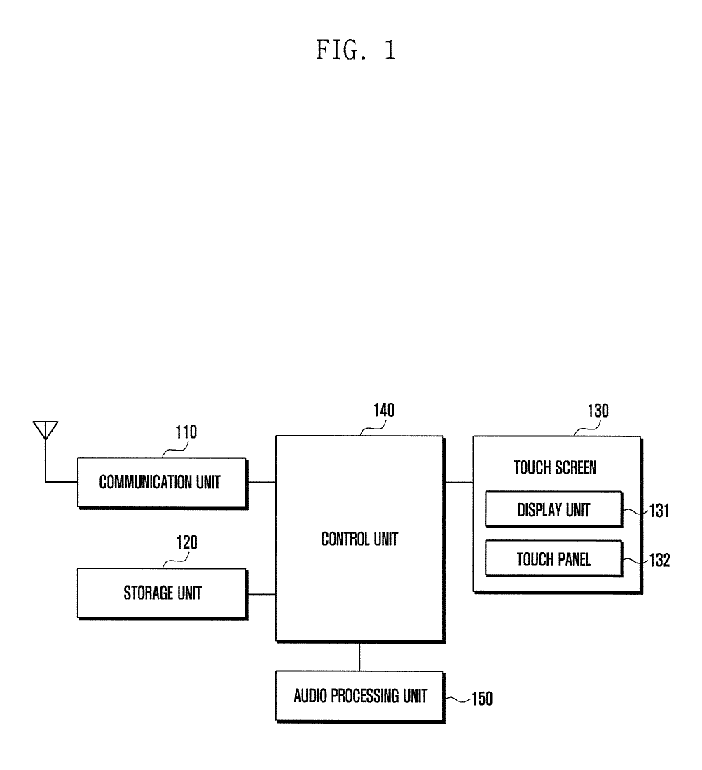

FIGS. 1 through 9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communications system. Hereinafter, the present disclosure will be described with reference to the accompanying drawings. The present disclosure has various embodiments, and modifications and changes made herein. Therefore, the present disclosure will be described in conjunction with particular embodiments shown in the accompanying drawings. However, it should be understood that the present disclosure is not limited to the specific embodiments, but the present disclosure includes all modifications, equivalents, and alternatives within the spirit and the scope of the present disclosure. In the description of the drawings, identical or similar reference numerals are used to designate identical or similar elements.

As used herein, the expression “include” or “may include” refers to the existence of a corresponding function, operation, or element, and does not exclude one or more additional functions, operations, or elements. The terms such as “include” or “have” can be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

Also, as used here, the expression “or” includes any or all combinations of words enumerated together. For example, the expression “A or B” can include A, can include B, or can include both A and B.

In the present disclosure, the expressions “a first”, “a second”, “the first”, “the second”, and the like can modify various elements, but the corresponding elements are not limited by these expressions. For example, the above expressions do not limit the sequence and/or importance of the corresponding elements. The above expressions can be used merely for the purpose of distinguishing one element from the other elements. For example, a first electronic device and a second electronic device indicate different user devices although both of them are user devices. For example, without departing from the scope of the present disclosure, a first structural element can be named a second structural element. Similarly, the second structural element also can be named the first structural element.

Unless defined otherwise, all terms used herein, including technical and scientific terms, have the same meaning as those commonly understood by a person of ordinary skill in the art to which the present disclosure pertains. Such terms as those defined in a generally used dictionary are to be interpreted to have the meanings equal to the contextual meanings in the relevant field of the art, and are not to be interpreted to have ideal or excessively formal meanings unless clearly defined in the present disclosure.

An electronic device according to the present disclosure is a device including a communication function. For example, the electronic device includes at least one of a smart phone, a tablet Personal Computer (PC), a mobile phone, a video phone, an e-book reader, a desktop PC, a laptop PC, a netbook computer, a Personal Digital Assistant (PDA), a Portable Multimedia Player (PMP), an MP3 player, a mobile medical device, a camera, and a wearable device (for example, a Head-Mounted-Device (HMD) such as electronic glasses, electronic clothes, an electronic bracelet, an electronic necklace, an electronic appcessory, an electronic tattoo, and a smart watch).

In certain embodiments of the present disclosure, situation information includes information on transmission and reception devices, user information of the transmission and reception devices, an encoded key, beacon strength information, and the like. In certain embodiments, the user information includes, for example, personal information (such as a VIP, a VVIP and the like) registered in a shop, current time information, a speed and the like. Specifically, a beacon signal is changed such that broad information or detailed information is received based on a beacon strength according to a distance between electronic devices. When a speed of the electronic device is fast, that is, a movement speed of a user is fast, the beacon signal is changed such that an advertisement is not received. The beacon signal is changed such that only necessary information such as traffic information in a case of a rush hour is received according to a current time, based on the current time information.

In addition, an electronic device according to certain embodiments of the present disclosure generates a beacon packet changed according to the situation information. Specifically, the electronic device changes parameter information such as contents (such as a text, an image, an audio, a video and the like) information, a reception period, a receiving object, a transmission power and the like according to the situation information, generate and transmit a beacon packet signal based on the changed parameter, and thus a user can receive proper information.

According to certain embodiments of the present disclosure, advertising is used as a term having the same meaning as the term ‘transmitting (such as broadcasting) a beacon signal.’

FIG. 1 illustrates a configuration of an electronic device having a touch device according to various embodiments of the present disclosure.

Referring to FIG. 1, an electronic device includes a communication unit 110, a storage unit 120, a touch screen 130, a control unit 140 and an audio processing unit 150.

The communication unit 110 performs a voice call, a video call or a data communication with an external device through a network. The communication unit 110 is configured with a Radio Frequency (RF) transmitter that up-converts and amplifies a frequency of a signal to be transmitted, and an RF receiver that low-noise amplifies a received signal and down-converts a frequency of the received signal. The communication unit 110 further includes a modulator and a demodulator. The modulator and the demodulator include functions of Code Division Multiple Access (CDMA), Wideband Code Division Multiple Access (WCDMA), Long Term Evolution (LTE), Wi-Fi, Wireless Broadband Internet (WiBro), BLUETOOTH, Near Field Communication (NFC), etc. The communication unit 110 is a mobile communication module, an Internet communication module or a short range communication module. In certain embodiments of the present disclosure, the communication unit 110 transmits and receives a beacon signal under a control of the control unit 140.

The storage unit 120 includes a program memory for storing an operation program of the electronic device and a data memory for storing data generated while a program is performed.

The touch screen 130 is configured to be an integral type touch screen, which includes a display unit 131 and a touch panel 132. The display unit 131 displays various screens according to use of the electronic device 100 under the control of the control unit 140. In addition, the display unit 131 is configured with a Liquid Crystal Display (LCD), an Organic Light Emitting Diode (OLED), an Active Matrix Organic Light Emitting Diode (AMOLED), a flexible display, a bended display, a 3D display, and the like. In addition, the display unit 131 is implemented to be flexible, transparent or wearable. In certain embodiments, the touch panel 132 is a composite touch panel including a hand touch panel for detecting a hand gesture and a pen touch panel for detecting a pen gesture.

The control unit 140 controls an overall operation of the electronic device and a signal flow between internal elements of the electronic device, performs data processing, and controls a supply of electric power from a battery to the internal elements. In certain embodiments of the present disclosure, the control unit 140 receives a beacon including the situation info illation from another electronic device by transmitting a beacon signal. The control unit 140 analyzes the received situation information, automatically generates a beacon packet suitable for the other electronic device based on the beacon changed according to the situation information, and transmits the generated beacon packet to the other electronic device.

The audio processing unit 150 is configured by a microphone MIC and a speaker SPK, and converts an analog voice signal input from the microphone MIC into a digital voice signal to output the converted digital voice signal to the speaker SPK. The audio processing unit 150 outputs various audio signals generated by the electronic device to the speaker SPK. In certain embodiments of the present disclosure, the speaker SPK transfers sound information output from the speaker SPK to the control unit 140 and transmits and receives the beacon signal through the communication unit 110.

The electronic device includes elements including additional functions such as a Global Positioning System (GPS) module for receiving location information, a broadcast receiving module for receiving a broadcasting, an input unit for supporting an input based on a hard key, and the like, but descriptions and drawings related to these elements omitted.

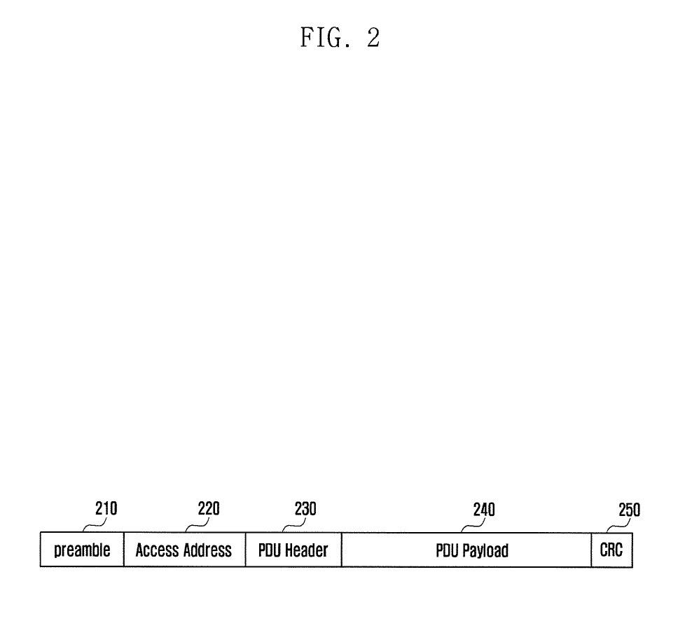

FIG. 2 illustrates a beacon according to various embodiments of the present disclosure. FIG. 2 illustrates a packet configuration of a BLE beacon according to various embodiments of the present disclosure. The packet configuration is not limited thereto, and may be different according to a communication method.

Referring to FIG. 2, the beacon includes a preamble 210, an access address 220, a Protocol Data Unit (PDU) header 230, a PDU payload 240 and a Cyclic Redundancy Check (CRC) 250. The preamble 210 includes information related to a frequency synchronization, a symbol timing estimation, an automatic gain control, and the like. In addition, the access address 220 includes information related to a physical link access code. According to certain embodiments of the present disclosure, the access address includes an address of a destination to which a beacon signal is transmitted, for example, all electronic devices or a specific electronic device. In addition, the PDU header 230 includes information related to a logical transport, logical link identifiers, and the like. According to certain embodiments of the present disclosure, the PDU header 230 includes information related to the PDU payload 240. The PDU payload 240 includes information related to a Logical Link Control and Adaptation Protocol (L2CAP) signal, L2CAP frames, user data, or the like. In certain embodiments, the user data includes media data such as an audio, a video, a text, and the like. According to certain embodiments of the present disclosure, the PDU payload 240 includes data to be transmitted to the access address 220. The CRC 250 includes information related to data transmission error detection, and the like.

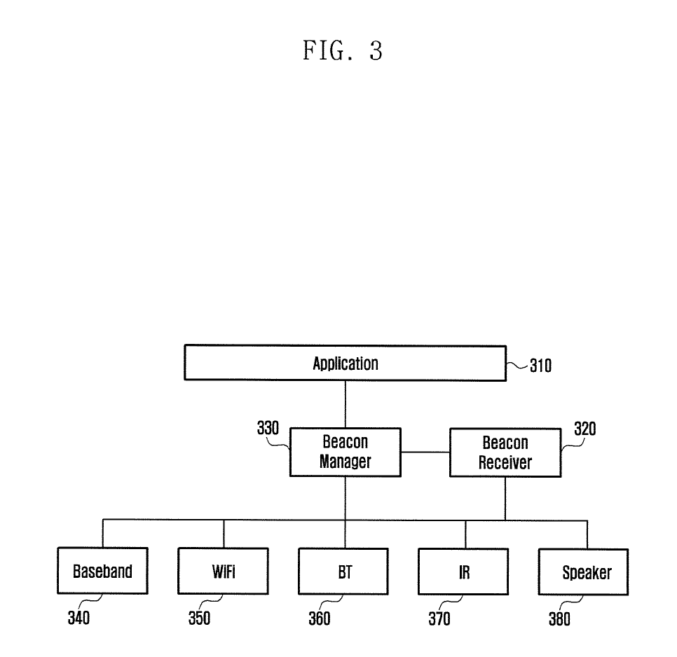

FIG. 3 illustrates components used in the process for transmitting and receiving a beacon according to various embodiments of the present disclosure.

Referring to FIG. 3, an application 310 applies or uses a beacon signal received through a beacon receiver 320. In addition, the application 310 plays a role of a beacon manager, which generates a beacon to be transmitted to another electronic device. The beacon receiver 320 receives the beacon signal from other electronic devices. A beacon manager 330 may analyzes the beacon signal received through the beacon receiver 320. A new beacon signal is generated according to a result of the analysis through the beacon manager 330 and the application 310. The generated beacon is transmitted and received through a baseband 340, a Wi-Fi 350, a BLUETOOTH (BT), an IR 370 and a speaker 380.

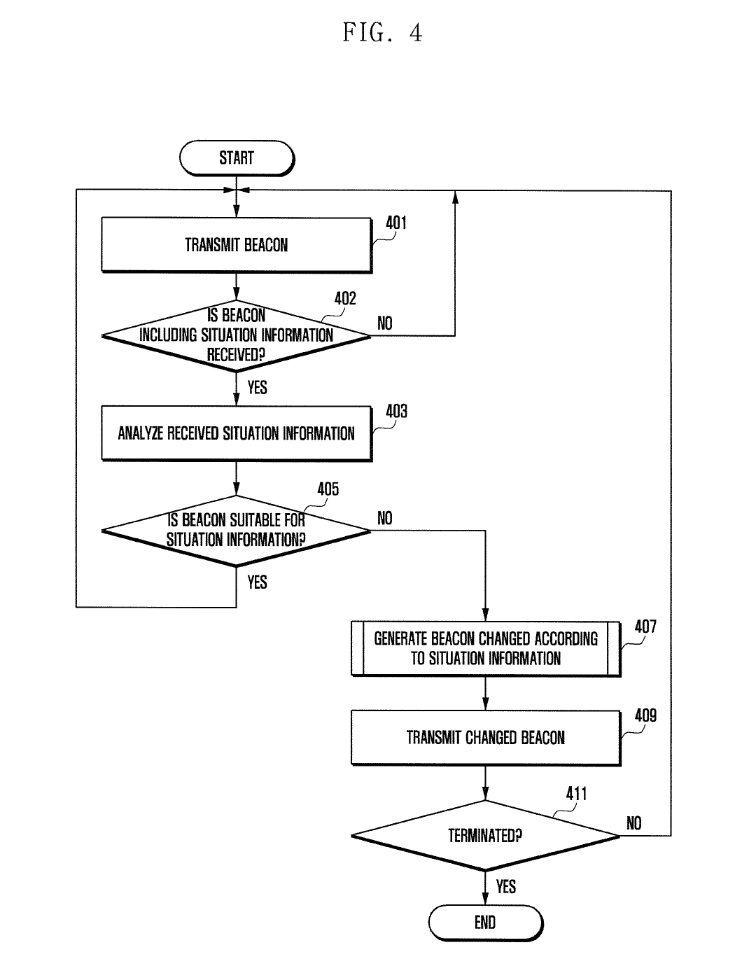

FIG. 4 illustrates an exemplary process for transmitting a changed beacon according to situation information in a transmitting electronic device.

In step 401, the control unit 140 transmits a beacon to a second electronic device during an advertising event. According to certain embodiments of the present disclosure, the beacon is transmitted to the second electronic device, which is a specific electronic device. But it is not limited thereto, the beacon may be transmitted to all electronic devices around a first electronic device.

In step 402, the control unit 140 determines whether a beacon including situation information of the second electronic device is received from the second electronic device.

In step 403, when the beacon including the situation information is received from the second electronic device in step 402, the control unit 140 detects and analyzes the situation information in the received beacon. In certain embodiments, the situation information includes a distance between electronic devices, a speed, current time information, a status of an electronic device which transmits a beacon, user information of transmitting and receiving electronic devices, and the like. When the control unit 140 receives the beacon including the user information (such as a user preference, activity information and the like) from the second electronic device, checks a currently transmitted beacon including contents to determine whether the contents of the beacon are suitable for a user of the second electronic device, and changes the beacon to include contents suitable for the user of the second electronic device when the change is necessary. For example, a beacon signal is changed such that broad information or detailed information is received based on a distance between the electronic devices. When a speed of the electronic device is fast or a movement speed of a user is fast, the beacon signal is changed such that an advertisement is not received. The beacon signal is changed such that only necessary information, such as traffic information in a case of a rush hour, is received according to a current time through the current time information.

In step 405, the control unit 140 determines whether the beacon transmitted to the second electronic device in step 401 is suitable for the situation information of the second electronic device through the analysis. When the beacon transmitted from the first electronic device to the second electronic device in step 401 is a beacon suitable for the situation information of the second electronic device in step 405, the control unit 140 repeatedly performs the operation of continuously transmitting the beacon, which is performed in step 401.

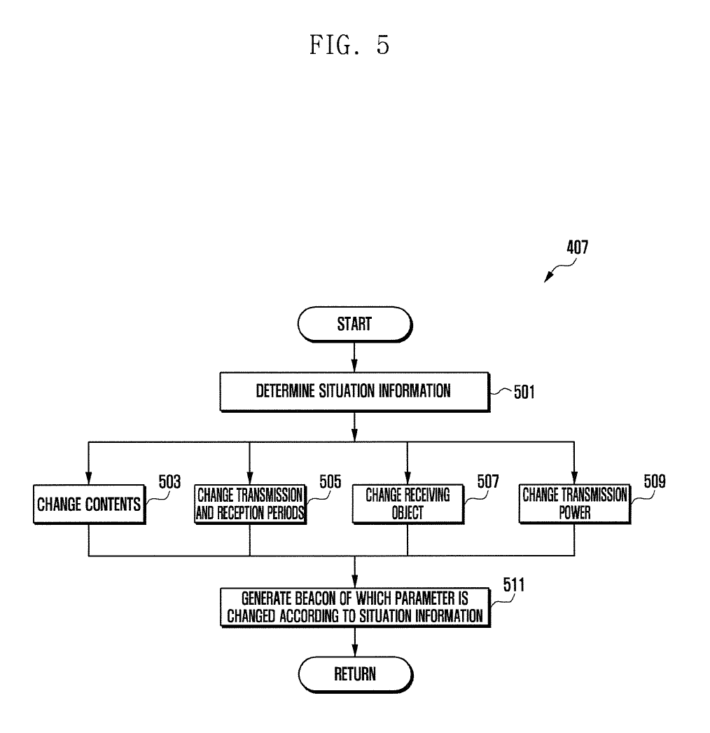

In step 407, when the beacon transmitted in step 401 is not the beacon suitable for the situation information of the second electronic device, the control unit 140 generates a changed beacon according to the situation information of the second electronic device. For example, when the first electronic device advertises a beacon signal including many contents (such as a text, an image, a video and the like) to all electronic devices, a specific electronic device, for example, the second electronic device among the electronic devices, receiving the beacon signal needs specific contents (such as the image). In certain embodiments, the first electronic device receives a beacon for a request for the specific contents (such as information requiring image contents). The first electronic device analyzes the beacon signal for the specific contents request, generates a changed beacon packet including only the specific contents required by the user of the second electronic device, and transmits the changed beacon packet to the second electronic device. Specific performance steps of step 407 in FIG. 4 are described in detail with reference to FIG. 5.

In step 409, the control unit 140 transmits the beacon (such as the beacon of which the parameter is changed according to the situation information) generated in step 407 to the second electronic device.

In step 411, the control unit 140 determines whether the operations of the method are terminated. When a termination command is generated in step 411, the control unit 140 performs a termination operation. In contrast, when the termination command is not generated, the control unit 140 transmits the beacon by returning to step 401.

FIG. 5 illustrates an exemplary process for generating a changed beacon according to situation information according to various embodiments of the present disclosure.

In step 501, the control unit 140 determines the situation information of the second electronic device. In steps 503 to 509, the control unit 140 changes parameter information corresponding to the situation information of the second electronic device. In step 503, the control unit 140 changes contents according to the situation information. In certain embodiments, the contents include a text, an image, an audio, a video and the like and are changed to correspond to the included situation information. In step 505, the control unit 140 changes transmission and reception periods according to the situation information. The control unit 140 changes the number of transmission and reception of the beacon in a specific time according to the situation information. In step 507, the control unit 140 changes a receiving object according to the situation information. In certain embodiments, a beacon receiving object is changed to at least one of a pre-registered subscriber, a subscriber registered in contact information, and a subscriber connected through an SNS. In step 509, the control unit 140 performs an operation of changing a transmission power according to the situation information. In various embodiments of the present disclosure, the control unit 140 generate a beacon of which at least one parameter of steps 503 to 509 is changed according to the situation information. In step 511, the control unit 140 generates the beacon that the parameter is changed according to the situation information by the operations of steps 503 to 509.

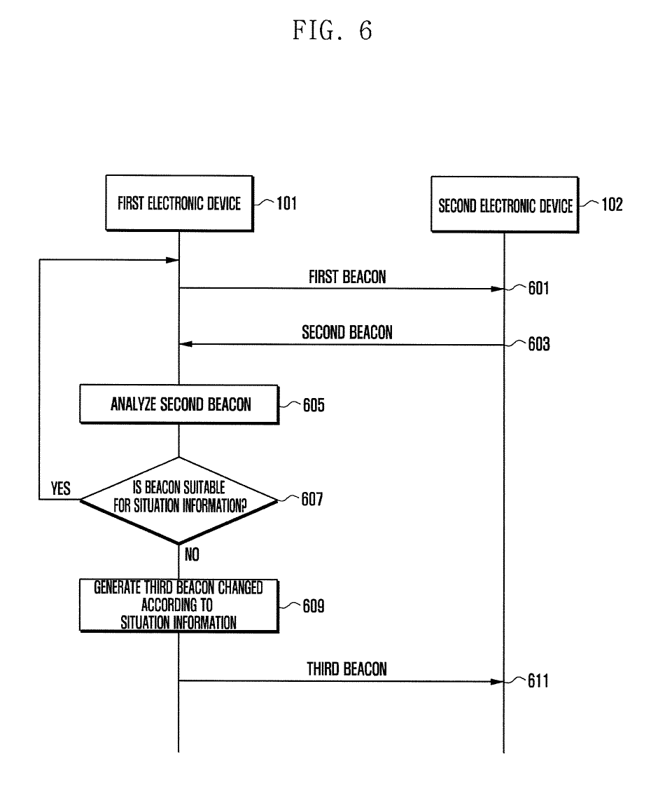

FIG. 6 illustrates a signal flow between the first electronic device and the second electronic device according to various embodiments of the present disclosure. Referring to FIG. 6, the first electronic device is a transmitting electronic device that transmits a beacon signal and the second electronic device is a receiving electronic device that receives the beacon signal.

The first electronic device 101 requests an advertisement enabling a link layer so that a beacon signal can be transmitted. When the advertisement is enabled, the first electronic device 101 transmits the beacon signal to the second electronic device 102. In certain embodiments of the present disclosure, the beacon signal is transmitted to the second electronic device 102, but the present disclosure is not limited thereto, and the beacon signal be transmitted to all electronic devices when a receiver is not determined. A scan mode of the second electronic device, in which the beacon signal is received, is in an activated state.

In step 601, the first electronic device 101 transmits a first beacon to the second electronic device 102 during an advertising event time. In step 603, the second electronic device 102 analyzes the received first beacon, generates a second beacon that is a response beacon suitable for the first beacon, and transmits the second beacon to the first electronic device 101. When the advertising event is finished, the first electronic device 101 receives the second beacon from the second electronic device 102. The second beacon includes address information of the second electronic device 102 and situation information of a PDU. For example, the situation information includes information such as a preference (such as a state of the electronic device and user information of the electronic device) of the second electronic device 102. The situation information includes contents requesting additional information to the first electronic device 101. In step 605, when the first electronic device 101 receives the second beacon including the situation information, the first electronic device 101 analyzes the received second beacon by scanning the received second beacon. In step 607, the first electronic device 101 determines whether the beacon signal transmitted to the second electronic device 102 in step 601 is a beacon suitable for a situation of the second electronic device 102. In step 609, when the beacon is a beacon that is not suitable for the situation information, the first electronic device 101 generates a third changed beacon according to the situation information. In step 611, the first electronic device 101 transmits the generated third beacon to the second electronic device 102 during the adverting event time, and the second electronic device 102 receives the beacon signal (such as the third beacon signal) suitable for the situation information.

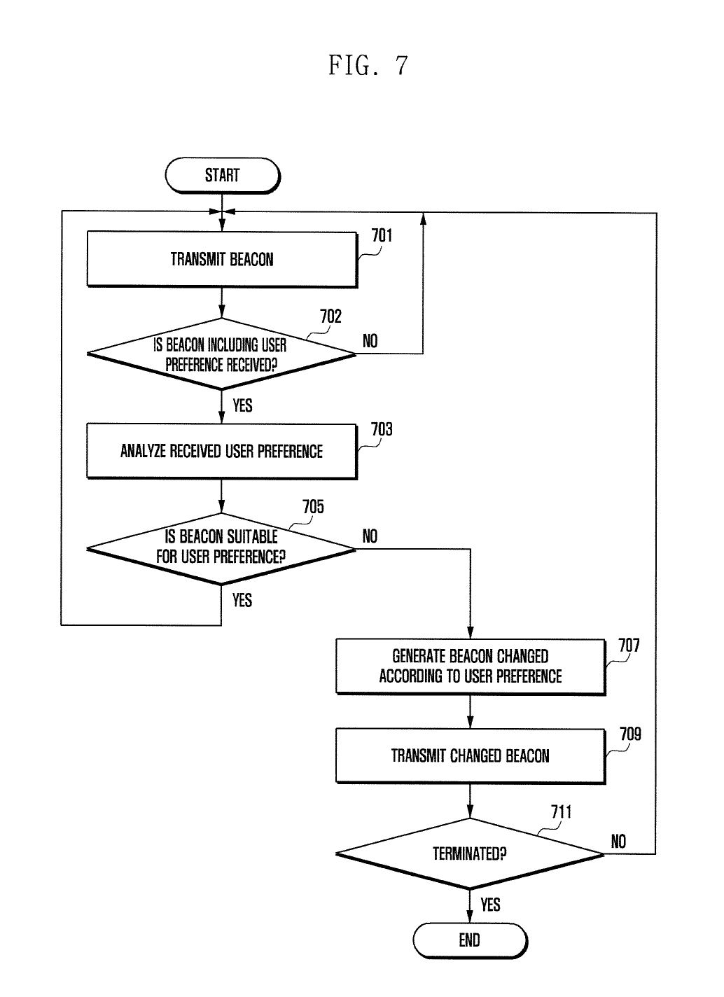

FIG. 7 illustrates and exemplary process for generating a changed beacon according to situation information according to various embodiments of the present disclosure. In FIG. 7, the situation information is user preference information.

In step 701, the control unit 140 transmits a beacon to the second electronic device during an advertising event. According to certain embodiments of the present disclosure, the beacon is transmitted to the second electronic device which is a specific electronic device, but it is not limited thereto, the beacon can be transmitted to all electronic devices around of a first electronic device. In step 702, the control unit 140 determines whether a beacon including a preference of a user (such as a user of the second electronic device) is received from the second electronic device.

In step 703, when the beacon including the preference information is received from the second electronic device in step 702, the control unit 140 analyzes the received beacon and the preference of the user using the second electronic device, which is included in the received beacon. In certain embodiments, the user preference includes a distance between electronic devices, a speed, current time information, information on transmitting and receiving devices, user information of the transmitting and receiving devices, information on a user preference, activity information, and the like. A beacon changed according to the user preference is generated. When the control unit 140 receives the beacon including the user information (such as the user preference, the activity information and the like) from the second electronic device, the control unit 140 checks a beacon including contents which is currently transmitted to determine whether the beacon is the contents suitable for the user of the second electronic device and changes the beacon to a beacon including contents suitable for the user of the second electronic device when the change is necessary to provide the changed beacon to the user of the second electronic device. For example, a beacon signal is changed such that broad information or detailed information is received based on a distance between the electronic devices. When a speed of the electronic device is fast, that is, a movement speed of a user is fast, the beacon signal is changed such that an advertisement is not received. The beacon signal is changed such that only necessary information such as traffic information in a case of a rush hour is received according to a current time, through on the current time information.

In step 705, the control unit 140 determines whether the beacon transmitted in step 701 is suitable for the preference information of the second electronic device through the analysis. In step 705, when the beacon is suitable for the preference information of the second electronic device, the control unit 140 repeatedly performs the operation of continuously transmitting the beacon previously transmitted by performing step 701.

In step 707, when the beacon transmitted in step 701 is not the beacon suitable for the preference information of the second electronic device, the control unit 140 generates a changed beacon according to the preference information. In certain embodiments, the parameter includes contents, a reception period, a receiving object, a transmission power and the like. The control unit 140 changes at least one parameter among the contents, transmission and reception periods, the receiving object and the transmission power according to the preference information and generates a beacon signal of which at least one parameter is changed.

In step 709, the control unit 140 transmits the beacon generated based on the parameter changed according to the user preference information to the second electronic device. According to certain embodiments of the present disclosure, the first electronic device is a shop electronic device which transmits advertisement information (such as coupon or discount information) to a user in a shop and the second electronic device is a user electronic device which receives the advertisement information from the shop (such as the first electronic device). The shop (such as the first electronic device) receives a beacon signal including the preference information (such as information on a personal registered in the shop, that is, the VIP and VVIP) from the user (such as the second electronic device) while the shop transmits a beacon signal including an advertisement. The shop receiving the beacon including the preference information generates a beacon packet changed to coupon or discount information (such as coupon or discount information corresponding to a VIP which the user preference information is the VIP) corresponding to the user preference information, and transmits the changed beacon packet to the user. In certain embodiments, the advertisement includes the coupon and discount information and is used as a meaning different from a term ‘transmitting (such as broadcasting or advertising) the beacon signal’.

In certain embodiments, when the shop transmits a first beacon including discount event information of a specific product, a B shop receiving the corresponding beacon generates a second beacon including information on an advertisement and/or a discount event of the same product and transmits the second beacon to a plurality of electronic devices.

In step 711, the control unit 140 determines whether the operations of the method are terminated. When a termination command is generated in step 711, the control unit 140 performs a termination operation. In contrast, when the termination command is not generated in step 711, the control unit 140 transmits the beacon by performing step 401.

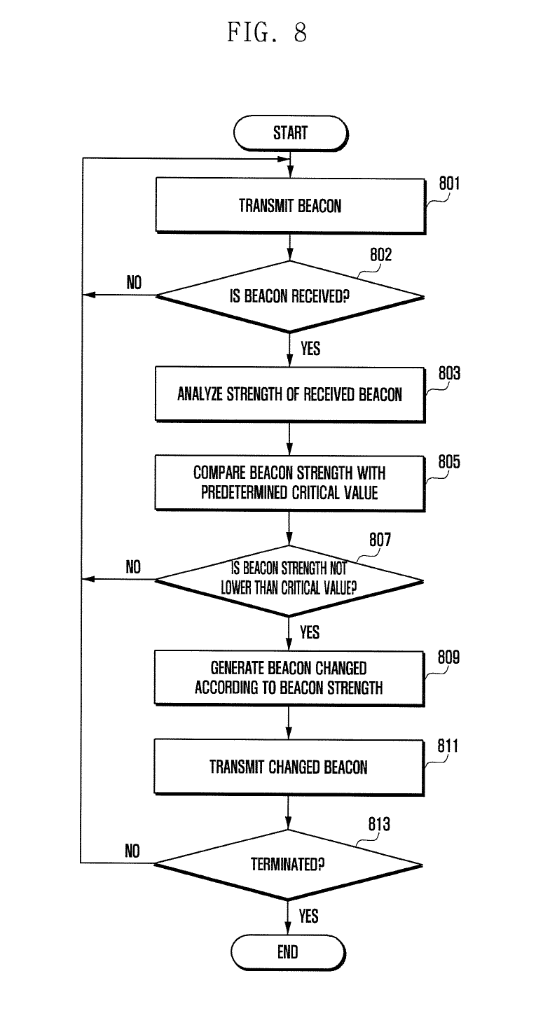

FIG. 8 illustrates an exemplary process for generating a changed beacon according to situation information according to various embodiments of the present disclosure. In FIG. 8, the situation information is beacon strength information.

In step 801, the control unit 140 transmits a beacon to the second electronic device during an advertising event. According to certain embodiments of the present disclosure, the beacon is transmitted to the second electronic device which is a specific electronic device, but it is not limited thereto, the beacon can be transmitted to all electronic devices around of a first electronic device. In step 802, the control unit 140 determines whether a beacon including the situation information is received from the second electronic device. In step 803, when the beacon is received in step 802, the control unit 140 analyzes the strength of the received beacon. In certain embodiments, the beacon strength information is strong when a distance between the electronic devices is short, and the beacon strength information is weak when the distance between the electronic devices is long. In step 805, the control unit 140 compares the analyzed beacon strength information with a predetermined critical value of the beacon strength. In step 807, the control unit 140 determines whether the beacon strength information is not lower than the predetermined critical value of the beacon strength. When the beacon strength information is lower than the critical value, such as when the distance between the electronic devices is long, the control unit 140 recognizes that the beacon strength is weak and transmits the beacon by performing step 801. In certain embodiment, the beacon is an existing beacon that is not changed.

In step 809, when the beacon strength information is equal to or higher than the critical value, that is, such as when the distance between the electronic devices is short, the control unit 140 recognizes that the beacon strength is strong and generates a beacon with the parameter information changed according to the beacon strength. The parameter information includes contents, a reception period, a receiving object, a transmission power and the like. The control unit 140 changes at least one parameter among the contents, transmission and reception periods, the receiving object and the transmission power according to the beacon strength information and generates a beacon signal of which at least one parameter is changed. In step 811, the control unit 140 transmits the beacon generated based on the parameter changed according to the beacon strength in step 809 to the second electronic device.

According to various embodiments of the present disclosure, the first electronic device is a shop electronic device that transmits advertisement information (such as advertisement information of the shop) to a user in the shop and the second electronic device is a user electronic device that receives the advertisement information from the shop (such as the first electronic device). The shop (such as the first electronic device) receives a beacon signal from the user (such as the second electronic device) while the shop transmits a beacon signal including the advertisement information. At this time, the information transmitted to the user is normal shop advertisement information (such as discount information of the shop as broad information). When a strength of this beacon signal is equal to or higher than a predetermined strength, it is determined that a user is close to a corresponding shop, a beacon signal (such as a beacon signal changed from the discount information of the shop to the coupon information usable in the shop according to the proximity of the user to the corresponding shop) changes to coupon or discount information usable in the corresponding shop, and transmits the generated beacon signal to the user. In certain embodiments, the advertisement includes the coupon and discount information, and is used as a meaning different from a term ‘transmitting (such as broadcasting or advertising) the beacon’ in certain embodiments of the present disclosure.

In step 813, the control unit 140 determines whether the operations of the method are terminated. When a termination command is generated in step 813, the control unit 140 terminates operation. In contrast, when the termination command is not generated, the control unit 140 transmits the beacon by performing step 801.

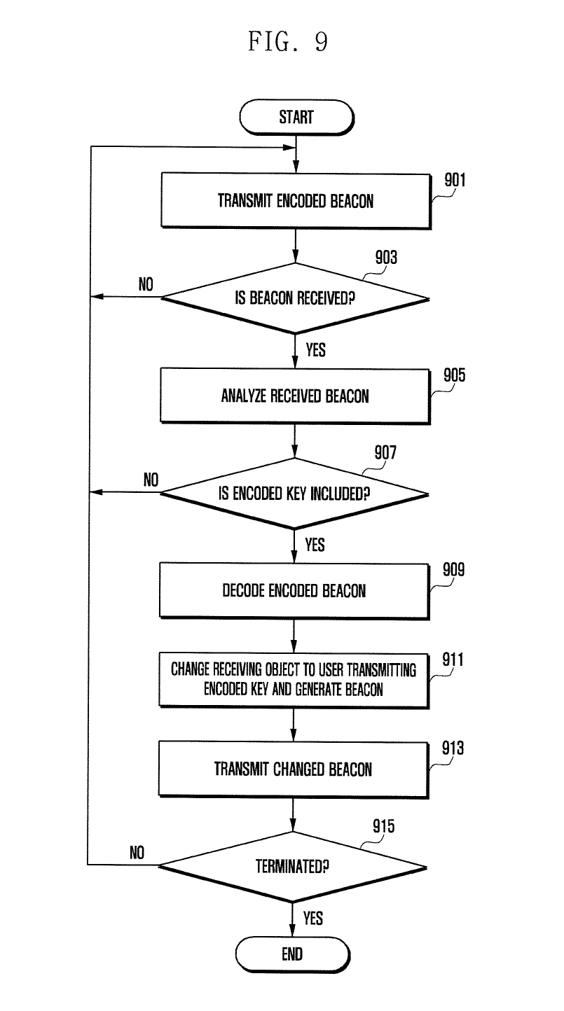

FIG. 9 illustrates an exemplary process for generating a changed beacon according to situation information according to various embodiments of the present disclosure.

In step 901, the control unit 140 transmits an encoded beacon that can only be opened by a specific receiver. In step 903, the control unit 140 determines whether the beacon is received from the second electronic device. The beacon is in a state that the beacon includes an encoded key or a state that the beacon does not include the encoded key. In step 905, when the beacon is received from the second electronic device in step 903, the control unit 140 analyzes the received beacon. In step 907, the control unit 140 determines whether the beacon includes the encoded key. In step 909, when the beacon includes the encoded key in step 907, the control unit 140 decodes the encoded beacon transmitted in step 901. In step 911, the control unit 140 generates a beacon which changes a beacon receiving object to the second electronic device transmitting the encoded key. In step 913, the control unit 140 transmits the beacon to the second electronic device.

For example, when a beacon is received from a specific user while an encoded beacon which can be opened by only the specific user is transmitted, the received beacon is analyzed. When it is determined that the beacon includes a key capable of decoding the encoded beacon through the analysis appointed to the beacon, the information opened to a corresponding user is transmitted. When security contents are transferred to many people in a specific space and a beacon including appointed key information is received from another electronic device during transmitting a beacon having information on an existing the security contents or a beacon signal having the security contents, the ID information of an electronic device transmitting a corresponding key beacon is determined as a target of a next beacon. A code of the contents is decoded and transmitted. In an operation of sharing the security contents, the sharing is smoothly performed in a high security level.

In step 915, the control unit 140 determines whether the operations of the method are terminated. When a termination command is generated in step 915, the control unit 140 terminates the operation. In contrast, the termination command is not generated in step 915, the control unit 140 performs step 901.

In step 907, when the beacon does not include the encoded key, the control unit 140 transmits the existing encoded beacon by performing step 901. According to certain embodiments of the present disclosure, the existing encoded beacon is transmitted when the beacon does not include the encoded key, but the present disclosure is not limited thereto, it can be determined whether the operations of the method are terminated by performing step 915.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method of controlling a beacon of an electronic device, the method comprising:
receiving a beacon including situation information;
analyzing the received situation information and generating a changed beacon according to the situation information; and
transmitting the generated beacon.

2. The method of claim 1, wherein the situation information includes at least one of user preference information, an encoded key and beacon strength information.

3. The method of claim 1, wherein the changed beacon is generated based on a parameter changed according to the situation information.

4. The method of claim 3, wherein the parameter includes contents, a beacon transmission and reception period, a beacon receiving object and a transmission power, and at least one of the parameter is changed.

5. The method of claim 4, wherein the contents includes at least one of an advertisement, a URL, a text, an image and a video.

6. The method of claim 4, wherein the beacon transmission and reception period includes the number of beacons transmitted and received in a specific time.

7. The method of claim 4, wherein the beacon receiving object includes at least one of a pre-registered subscriber, a subscriber registered in contact information and a subscriber connected through an SNS.

8. The method of claim 2, further comprising:
determining whether the beacon is suitable for user preference information, when the situation information is the user preference information; and
generating and transmitting a changed beacon according to the user preference information when the beacon is not suitable for the user preference information.

9. The method of claim 2, further comprising:
decoding an encoded beacon which is pre-transmitted, when the situation information is the encoded key; and
generating and transmitting a change beacon that changes a beacon receiving object into an electronic device transmitting the encoded key.

10. The method of claim 2, further comprising:
analyzing a strength of a received beacon, when the situation information is beacon strength information; and
comparing the beacon strength with a predetermined critical value, and generating and transmitting a changed beacon according to the beacon strength when the beacon strength is equal to or higher than the critical value.

11. An apparatus configured to control a beacon of an electronic device, the apparatus comprising:
a communication unit configured to transmit and receive a beacon; and
a control unit configured to:
receive a beacon including situation information;
analyze the received situation information;
generate a changed beacon according to the situation information and
transmit the changed beacon.

12. The apparatus of claim 11, wherein the control unit is further configured to generate the changed beacon based on a parameter changed according to the situation information including at least one of user preference information, an encoded key and beacon strength information.

13. The apparatus of claim 12, wherein the control unit is further configured to change a parameter including contents, a beacon transmission and reception period, a beacon receiving object and a transmission power.

14. The apparatus of claim 13, wherein the control unit is further configured to change at least one contents among an advertisement, a URL, a text, an image and a video according to the situation information.

15. The apparatus of claim 13, wherein the control unit is further configured to change the number of beacons transmitted and received in a specific time according to the situation information.

16. The apparatus of claim 13, wherein the control unit is further configured to change a beacon receiving object into at least one of a pre-registered subscriber, a subscriber registered in contact information and a subscriber connected through an SNS according to the situation information.

17. The apparatus of claim 11, wherein the control unit is further configured to transmit and receive the beacon through at least one of a mobile communication module, a WiFi, an Infrared (IR) communication, a BLUETOOTH and a speaker.

18. The apparatus of claim 12, wherein the control unit is further configured to:
determine whether the beacon is suitable for user preference information when the situation information is the user preference information; and
generate and transmit a changed beacon according to the user preference information when the beacon is not suitable for the user preference information.

19. The apparatus of claim 12, wherein the control unit is further configured to:
decode an encoded beacon which is pre-transmitted when the situation information is the encoded key; and
generate and transmit a changed beacon which changes a beacon receiving object into an electronic device transmitting the encoded key.

20. The apparatus of claim 12, wherein the control unit is further configured to:
analyze a strength of a received beacon when the situation information is a beacon strength signal;
compare the beacon strength with a predetermined critical value; and
generate and transmit a changed beacon according to the beacon strength when the beacon strength is equal to or higher than the critical value.
